(19) United States
(12) Patent Application Publication
(10) Pub. No.: US 2016/0047706 A1
(43) Pub. Date: Feb. 18, 2016

(54) PIPING PROBLEM SENSING DATA LOGGER, PIPING STRUCTURE, AND PIPING PROBLEM SENSING SYSTEM

(71) Applicant: NEC CORPORATION, Tokyo (JP)

(72) Inventors: Yuji MARUTA, Tokyo (JP); Yui IWANE, Tokyo (JP)

(21) Appl. No.: 14/778,826

(22) PCT Filed: Oct. 18, 2013
(86) PCT No.: PCT/JP2013/078262

§ 371 Date: Sep. 21, 2015

(30) Foreign Application Priority Data
Mar. 29, 2013 (JP) 2013-070886

(51) Int. Cl. G01M 3/24; G01H 17/00

(52) U.S. Cl. CPC G01M 3/243; G01H 17/00

(57) ABSTRACT

A piping problem sensing data logger that acquires vibration data of high quality and improves the accuracy of problem sensing because the installation method can be standardized and that reduces the risk of being detached from piping and the possibility of being lost after someone detaches it because it can be stationary-installed. The piping problem sensing data logger (1) includes a bolt portion (10) and an antenna portion (13). The bolt portion (10) includes a bolt head portion (12) and a bolt thread (11). The antenna (13) is disposed on an opposite side of the bolt head portion (12) from the bolt thread (11) or disposed in the bolt head portion (12). The bolt head portion (12) includes a vibration detection element (121), a memory unit (122), a control unit (123), a wireless control unit (124), a clock device (125), and a power-supply device (126).

### TECHNICAL FIELD

The present invention relates to a piping problem sensing data logger, a piping structure, and a piping problem sensing system.

### BACKGROUND ART

The water leakage from piping in water supply facilities is a serious social problem. The sensing of the water leakage from piping buried in the ground and the location of the water leakage has been performed by the auditory sense of a skilled inspector. For example, the sensing is performed as follows. The inspector checks the water leakage sound by the auditory sense in the quiet of the midnight or the like at valves and the like exposed to the ground surface. If there is the water leakage sound, the inspector moves along the pipeline while placing a special sound sensor on the ground surface to sense the site where the water leakage sound is clearest. In this manner, the inspector identifies the water leakage site. Although this method does not require expensive equipment and the like, there are problems in that the method requires skilled inspectors and individual skills greatly vary even among the skilled inspectors.

Hence, as an attempt to sense the water leakage without relying on the human sense, for example, the method of identifying the location of the water leakage by attaching an acoustic sensor or a vibration sensor on piping has been considered (for example, see Patent Documents 1 and 2). In this method, the direct installation of a vibration sensor-equipped water leakage sensing data logger to a water pipe by utilizing the space in a manhole is considered. There are two types of vibration sensor-equipped water leakage sensing data loggers: the one is attached on a water pipe with a magnet and the other is detachable from a water pipe.

### CITATION LIST

### Patent Document(s)

Patent Document 1: Japanese Patent No. 3032090

Patent Document 2: JP 2001-156514 A

### SUMMARY OF INVENTION

### Problem to be Solved by the Invention

As for the data logger that is attached on a water pipe with a magnet, it is difficult to install the data logger if the space around the water pipe in a manhole is small. Also in the case of installing the data logger at a site where a magnet is not attracted, since the data logger cannot be installed as it is, there has been a method of attaching a clamp or the like to which the magnet is attracted on a water pipe and attaching the data logger on the clamp. However, since respective pieces of vibration data acquired by the respective data loggers attached on different places or attached by different methods have different properties, the accuracy degradation of the result of water leakage sensing is induced.

As for the detachable data logger, there is a case where a person involved in some kind of work in a manhole detaches the data logger and does not install it again after the work, and this makes the measurement of data incapable thereafter. Also there is a case of losing a data logger after detachment.

The water leakage sensing using the aforementioned data logger is mainly intended to a case of attaching a data logger before water leakage sensing and detaching the data logger after the sensing. However, since the sensing frequency is high in a place equipped with deteriorated water pipes that often cause water leakage, to detach the data logger each time is very burdensome.

The present invention is intended to provide a piping problem sensing data logger that acquires vibration data of high quality and improves the accuracy of problem sensing because the installation method can be standardized and that reduces the risk of being detached from piping and the possibility of being lost after someone detaches it because it can be stationary-installed. The present invention is also intended to provide a piping structure and a piping problem sensing system that use the piping problem sensing data logger.

### MEANS FOR SOLVING PROBLEM

In order to achieve the above object, the present invention provides a piping problem sensing data logger including: a bolt portion including a bolt head portion and a bolt thread; and an antenna portion disposed on an opposite side of the bolt head portion from the bolt thread or disposed in the bolt head portion, wherein the bolt head portion includes a vibration detection element, a memory unit, a control unit, a wireless control unit, a clock device, and a power-supply device.

The present invention also provides a piping structure in which a plurality of piping units are connected, wherein at least one of bolts that connect adjacent piping units is the piping problem sensing data logger of the present invention.

The present invention also provides a piping problem sensing system including: a piping problem sensing data logger; and a server, wherein the piping problem sensing data logger is the piping problem sensing data logger of the present invention, and the server is connected to the piping problem sensing data logger via a communication network and analyzes vibration data acquired by the piping problem sensing data logger.

### EFFECTS OF THE INVENTION

According to the present invention, it is possible to provide a piping problem sensing data logger that acquires vibration data of high quality and improves the accuracy of problem sensing because the installation method can be standardized and that reduces the risk of being detached from piping and the possibility of being lost after someone detaches it because it can be stationary-installed. According to the present invention, it is also possible to provide a piping structure and a piping problem sensing system that use the piping problem sensing data logger.

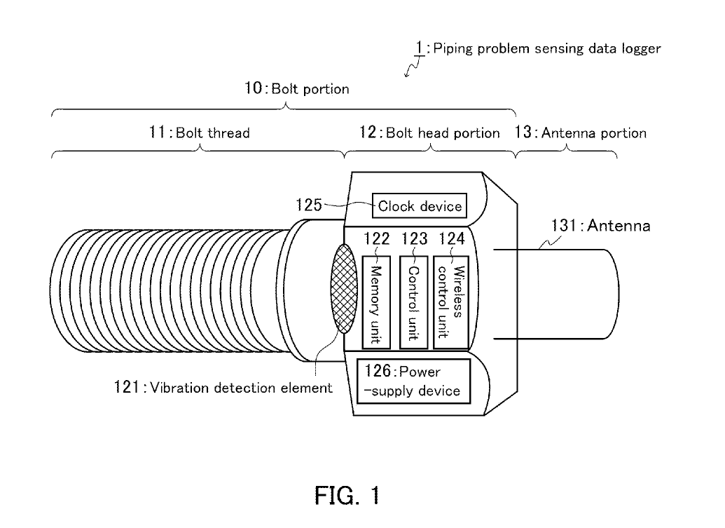

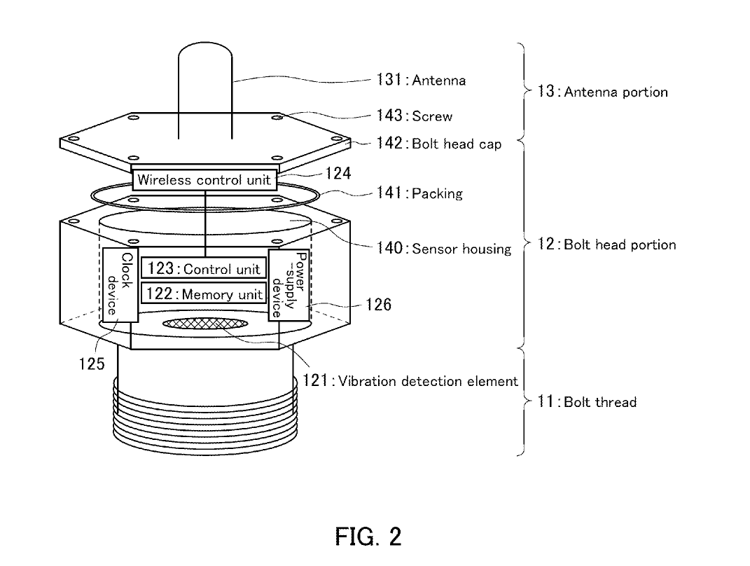

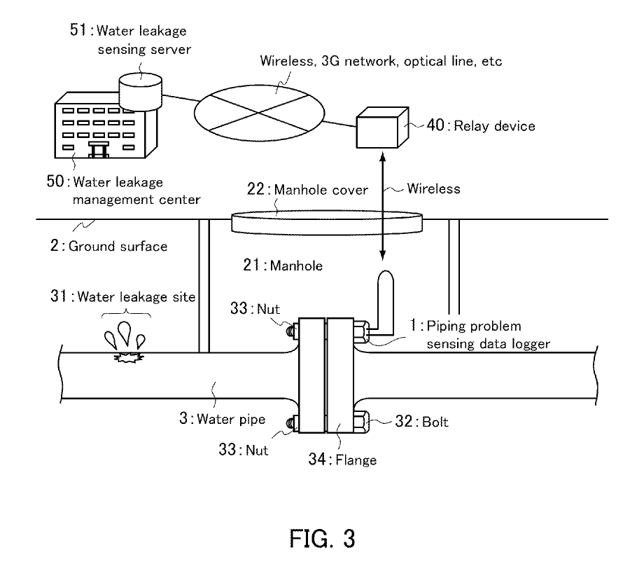

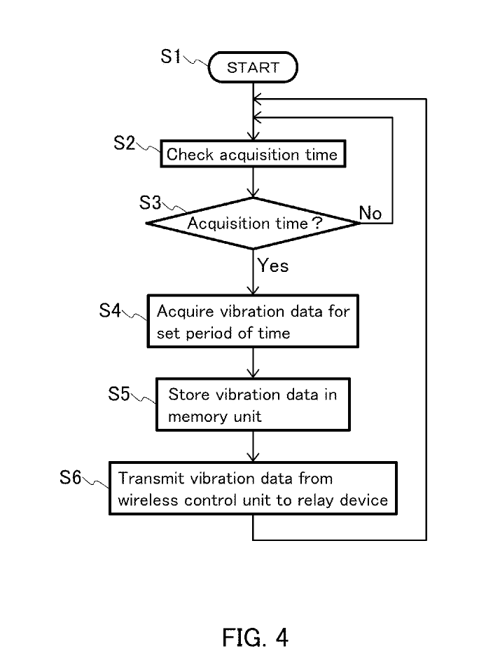

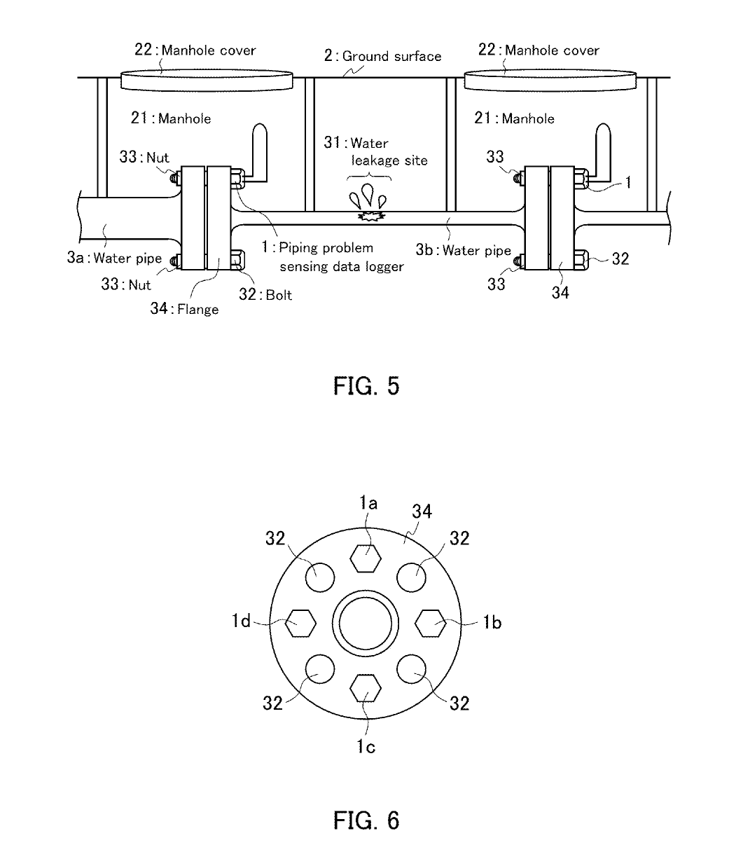

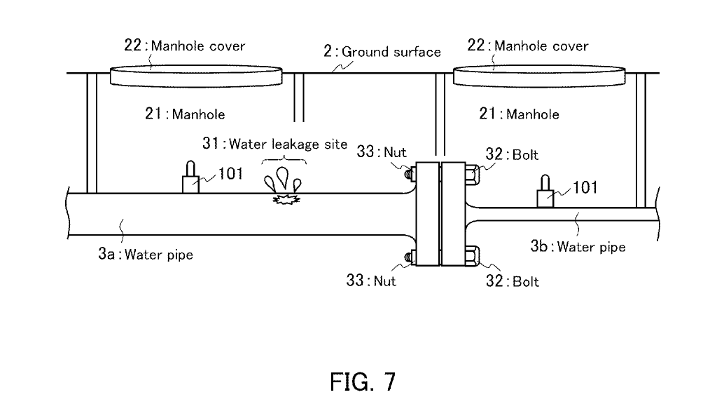

### BRIEF DESCRIPTION OF DRAWINGS

[FIG. 1] FIG. 1 is a schematic view showing the configuration of an example of the piping problem sensing data logger of the present invention.

[FIG. 2] FIG. 2 is a schematic view for explaining the opening and closing of the bolt head portion of the piping problem sensing data logger shown in FIG. 1.

[FIG. 3] FIG. 3 is a conceptual diagram of an example of the piping structure and the piping problem sensing system that use the piping problem sensing data logger of the present invention.

[FIG. 4] FIG. 4 is a flowchart for explaining an example of the operation of the piping problem sensing data logger and the piping problem sensing system of the present invention.

[FIG. 5] FIG. 5 is a conceptual diagram of another example of the piping structure that uses the piping problem sensing data logger of the present invention.

[FIG. 6] FIG. 6 is a schematic view of an example of the connection surface of the flange in the piping structure that uses the piping problem sensing data logger of the present invention.

[FIG. 7] FIG. 7 is a conceptual diagram of an example of the piping structure that uses a common vibration sensor-equipped water leakage sensing data logger.

### DESCRIPTION OF EXEMPLARY EMBODIMENT

In the piping problem sensing data logger of the present invention, preferably, the bolt head portion is composed of a bolt head cap, a sensor housing, and a packing, the bolt head cap is connected to the antenna portion, the sensor housing is connected to the bolt thread, the wireless control unit is disposed on a surface of the bolt head cap adjacent to the sensor housing, the vibration detection element, the memory unit, the control unit, the clock device, and the power-supply device are housed in the sensor housing, and the bolt head cap and the sensor housing are joined with the packing interposed therebetween.

Preferably, the piping problem sensing data logger of the present invention is a bolt that connects piping units.

In the piping problem sensing data logger of the present invention, preferably, the piping is a water pipe, and the piping problem sensing data logger senses a water leakage of the water pipe.

The piping problem sensing system of the present invention may further include a relay device, wherein the relay device may be connected wirelessly to the piping problem sensing data logger, and the server may be connected to the relay device via a communication network.

In the piping structure and the piping problem sensing system of the present invention, preferably, at least two of bolts that connect adjacent piping units are the piping problem sensing data loggers of the present invention.

In the piping structure and the piping problem sensing system of the present invention, preferably, at least two pieces of vibration data are acquired by at least two piping problem sensing data loggers.

In the piping problem sensing system of the present invention, preferably, a piping problem sensing data logger that acquired stronger vibration data among at least two piping problem sensing data loggers is identified to determine a location where a problem is caused in the piping.

In the piping problem sensing system of the present invention, preferably, at least three of bolts that connect adjacent piping units are the piping problem sensing data loggers of the present invention, respective pieces of vibration data acquired by the respective piping problem sensing data loggers are compared one another in the server, and a piping problem sensing data logger that acquired vibration data significantly different from those of other piping problem sensing data loggers is determined to be defective.

In the piping structure and the piping problem sensing system of the present invention, preferably, the piping is a water pipe, and the piping problem sensing data logger senses a water leakage of the water pipe.

Hereinafter, the piping problem sensing data logger, the piping structure, and the piping problem sensing system of the present invention will be described in detail with reference to examples. It is to be noted, however, that the present invention is not limited to the following examples. With respect to the following FIGS. 1 to 7, identical parts are indicated with identical numerals and symbols.

[Piping problem sensing data logger]

FIG. 1 shows the configuration of an example of the piping problem sensing data logger of the present invention. As shown in FIG. 1, piping problem sensing data logger 1 of the present example includes bolt portion 10 and antenna portion 13. Bolt portion 10 includes bolt head portion 12 and bolt thread 11. Antenna portion 13 is disposed on an opposite side of bolt head portion 12 from bolt thread 11. Antenna portion 13 may be disposed in bolt head portion 12. Bolt head portion 12 includes vibration detection element 121, memory unit 122, control unit 123, wireless control unit 124, clock device 125, and power-supply device 126.

Bolt thread 11 is in a shape similar to a common bolt thread and can be screwed into a nut.

An example of vibration detection element 121 includes a vibration sensor, and vibration detection element 121 acquires vibration data transmitted from piping. The acquired vibration data is stored in memory unit 122. Besides the vibration data, memory unit 122 stores the individual identification (ID) of piping problem sensing data logger 1, the acquisition time of vibration data, the set period of time for one acquisition, the transmitting time of vibration data, and the like. Control unit 123 controls the overall piping problem sensing data logger 1. For example, control unit 123 controls the operation of vibration detection element 121 and the access to memory unit 122, e.g., the start of vibration data acquisition and the completion of vibration data acquisition. Wireless control unit 124 is a wireless transmit/receive interface. Clock device 125 is an internal clock of piping problem sensing data logger 1. For example, clock device 125 has a function of correcting the time by synchronizing with the time input to a server of the piping problem sensing system that will be described below. An example of power-supply device 126 includes a small long-life battery.

An example of antenna portion 13 includes wireless antenna 131.

With reference to FIG. 2, the opening and closing of the bolt head portion 12 will be described. As shown in FIG. 2, bolt head portion 12 is composed of bolt head cap 142, sensor housing 140, and packing 141 such as a rubber packing. Bolt head cap 142 is connected to antenna portion 13. Sensor housing 140 is connected to bolt thread 11. Wireless control unit 124 is disposed on a surface of bolt head cap 142 adjacent to sensor housing 140. Vibration detection element 121, memory unit 122, control unit 123, clock device 125, and power-supply device 126 are housed in sensor housing 140. Since the top of bolt head portion 12 is detachable as a bolt head cap 142, inner components such as power-supply device 126 and the like are replaceable. Bolt head cap 142 and sensor housing 140 are joined with screws 143 with packing 141 interposed therebetween. A rivet or the like can be used instead of screw 143. This allows the bolt head portion 12 to have a sealed structure that prevents water, dust, and the like from being entered. It is to be noted that FIG. 2 is merely illustrative, and bolt head portion 12 may be in a form different from that shown in FIG. 2.

Piping problem sensing data logger 1 can be used as a bolt that connects piping units, for example.

According to piping problem sensing data logger 1 of the present invention, it is possible to acquire vibration data of high quality and improve the accuracy of problem sensing because the installation method in piping can be standardized. Furthermore, since piping problem sensing data logger 1 of the present invention is stationary-installed in piping, it is possible to reduce the risk of being detached from the piping and the possibility of being lost after someone detaches it. Thus it is possible to reduce the cost for purchasing alternative piping problem sensing data logger 1 and the costs for resetting and reinstallation.

The operation of piping problem sensing data logger 1 will be described in the description for the piping problem sensing system that will be described below.

[Piping structure and piping problem sensing system]

FIG. 3 shows an example of the piping structure and the piping problem sensing system that use piping problem sensing data logger 1 shown in FIG. 1. In the present example, the piping is water pipe (for example, a water supply pipe, a sewer pipe, etc.) 3. This is an example of a water pipe structure and a water pipe leakage sensing system in which piping problem sensing data logger 1 senses the water leakage of the water pipe.

As shown in FIG. 3, piping problem sensing data logger 1 is used at flange 34 that connects water pipes 3 below manhole 21. While water pipes 3 are connected generally with bolts 32 and nuts 33, piping problem sensing data logger 1 of the present invention is used instead of at least one of bolts 32. Piping problem sensing data logger 1 acquires vibration data of water pipe 3. The acquired vibration data is wirelessly transmitted by antenna 31 of piping problem sensing data logger 1 to outdoor relay device 40. Relay device 40 may be stationary-installed outdoors, e.g., on a utility pole, the roof of a building, a public facility, and the like or installed in a bicycle, a motor vehicle, and the like to acquire vibration data while moving. Then, the vibration data is transmitted from relay device 40 to water leakage sensing server 51 at water leakage management center 50. Relay device 40 and water leakage sensing server 51 are connected via a communication network. The communication network is not a component of the piping problem sensing system of the present invention. For example, a cable network such as an optical line or a wireless network such as a 3G network, a LTE network, or the like can be utilized. In the water pipe leakage sensing system of the present example, relay device 40 is an optional component. Piping problem sensing data logger 1 and water leakage sensing server 51 may be connected directly via a communication network without involving relay device 40. For example, water leakage management center 50 can be located at a waterworks bureau of a local government, a third-sector of a waterworks bureau, and the like. The respective pieces of vibration data acquired by the respective piping problem sensing data loggers 1 installed in an analysis area are analyzed by water leakage sensing server 50 to explore the possibility of a water leakage in the analysis area. On the basis of the result of the correlation analysis of more than one piping problem sensing data logger 1, the place where a water leakage is presumed (water leakage site 31) is calculated. It is to be noted that, in FIG. 3, 2 indicates the ground surface and 22 indicates the manhole cover.

With reference to the flowchart of FIG. 4, the operation of piping problem sensing data logger 1 and the water pipe leakage sensing system of the present example is described. After the start of the processing (step 1 (S1)), first, piping problem sensing data logger 1 checks the acquisition time stored in memory unit 122 in step 2 (S2). Next, in step 3 (S3), piping problem sensing data logger 1 checks if it is the acquisition time. If it is not the acquisition time (No), the procedure returns to step 2 (S2) to check the acquisition time, and if it is the acquisition time (Yes), vibration data is acquired for a set period of time stored in memory unit 122 (step 4 (S4)). After the completion of acquisition, the vibration data is stored in memory unit 122 in step 5 (S5). Thereafter, when the acquired data transmission time stored in memory unit 122 comes, the vibration data stored in memory unit 122 is transmitted from wireless control unit 124 to relay device 40 via antenna 131 in step 6 (S6), and the procedure returns to step 2 (S2) to check the acquisition time.

The setting information of piping problem sensing data logger 1 such as the individual identification (ID), the acquisition time, the set period of time, the acquired data transmission time, or the like may be remotely changeable at water leakage management center 50. Also water pipe leakage sensing system of the present example may have a function of delivering various items of setting data to the respective piping problem sensing data loggers 1 via relay device 40 upon receipt of the data to water leakage sensing server 51 and automatically changing the set values of the respective piping problem sensing data loggers 1. The water pipe leakage sensing system of the present example may have a function of managing a battery remaining amount and automatically transmitting the information to water leakage sensing server 51 when the battery remaining amount got low.

Piping problem sensing data logger 1 may have a mechanism of keeping the acquired data stored in memory unit 122 for several days to several weeks and of automatically deleting the data in chronological order so that new data remains.

In the water pipe leakage sensing system of the present example, piping problem sensing data logger 1 may be allowed to start the acquisition of vibration data at the timing of the receipt of the acquisition request transmitted from water leakage sensing server 51 at water leakage sensing center 50.

In the water pipe leakage sensing system of the present example, piping problem sensing data logger 1 may be allowed to transmit vibration data to relay device 40 at the timing of the receipt of the data request transmitted from water leakage sensing server 51 at water leakage sensing center 50.

FIG. 5 shows another example of the piping structure that uses piping problem sensing data logger 1 shown in FIG. 1. As shown in FIG. 5, the piping structure of the present example has the same configuration as the piping structure shown in FIG. 3 except that the bore and material are different between connected water pipes 3a and 3b. The piping structure of the present example can be applied to the piping problem sensing system shown in FIG. 3.

When the bore and material are different between water pipes 3a and 3b, the transmission speed and the property of the vibration data are different between water pipes 3a and 3b. If the features of the vibration data are different between water pipes 3a and 3b, it is difficult to correct the vibration data due to the difference in the water pipes in the piping structure that uses common vibration sensor-equipped water leakage sensing data loggers 101 that are directly installed at water pipes as shown in FIG. 7. Thus the sensing accuracy decreases at the time of calculating the distances (m) between water leakage site 31 and the adjacent two vibration sensor-equipped water leakage sensing data loggers 101 based on the correlation between adjacent two vibration sensor-equipped water leakage sensing data loggers 101 respectively installed at water pipe 3a and 3b.

In contrast, in the piping structure of the present example, since piping problem sensing data logger 1 is used at flange 34 that connects water pipes, as shown in FIG. 5, piping problem sensing data logger 1 is always present at each end of the respective water pipes. Thus the vibration data with respect to one water pipe 3b of the same bore and material can be acquired by two piping problem sensing data loggers 1 at both ends of water pipe 3b. This improves the sensing accuracy at the time of calculating the distances (m) between water leakage site 31 and the adjacent two piping problem sensing data loggers 1.

FIG. 6 shows an example of the connection surface of the flange in the piping structure that uses the piping problem sensing data logger of the present invention. This is an example in which more than one piping problem sensing data logger is used at flange 34. Except for this, the piping structure of the present example is the same as the piping structures respectively shown in FIG. 3 and FIG. 5. As shown in FIG. 6, in the piping structure of the present example, four piping problem sensing data loggers 1a to 1d and four bolts 32 are used at flange 34. In FIG. 6, the number of piping problem sensing data loggers is four. In the present example, it is acceptable as long as there is more than one (at least two) piping problem sensing data logger and it is preferable if there are at least three piping problem sensing data loggers.

When more than one piping problem sensing data logger is used at flange 34, since the number of pieces of acquired vibration data increases, the sensing accuracy increases. Furthermore, by identifying the piping problem sensing data logger that acquired stronger vibration data among more than one piping problem sensing data logger, it is possible to determine the location of the water leakage site in the water pipe. For example, when two piping problem sensing data loggers are used at the top and bottom or the right and left of flange 34, it is possible to determine whether the water leakage site is at the upper side or the lower side or the right side or the left side of the water pipe. When at least three piping problem sensing data loggers are used at flange 34, it is possible to determine the location of the water leakage site in the water pipe more precisely. For example, in the piping structure shown in FIG. 6, if piping problem sensing data loggers 1c and 1d sense stronger vibration data, it can be determined that the water leakage is at the lower left of the water pipe.

In the piping problem sensing system that uses the piping structure of the present example, by recording the location of the water leakage in the water pipe in the water leakage sensing server at the time of repairing the water pipe after sensing the water leakage, storing the respective pieces of vibration data acquired by the respective piping problem sensing data loggers in the water leakage sensing server, and comparing the acquired data with the data stored in the past when the water leakage is sensed thereafter, it is possible to build a system that determines the location of the water leakage in the water pipe.

There are needs for grasping the location of the water leakage beforehand because large-scale equipment is required for repairing the water pipe if the water leakage is at the lower side of the water pipe. According to this example, it is possible to grasp the location of the water leakage beforehand.

In the piping problem sensing system of the present invention, when at least three piping problem sensing data loggers are installed at flange 34, if there is a piping problem sensing data logger that acquired vibration data significantly different from others as a result of comparison of the respective pieces of vibration data acquired by the respective piping problem sensing data loggers in the water leakage sensing server, the one can be determined to be defective. In this manner, the easy grasp of the piping problem sensing data logger that is possibly defective increases the maintainability of the piping problem sensing system. Also in a water leakage management server, by not using the piping problem sensing data logger determined to be defective for the water leakage sensing but employing the average of the respective pieces of vibration data acquired by the rest of piping problem sensing data loggers for the correlation analysis and the like, the sensing accuracy of the piping problem sensing system increases. In the piping problem sensing system of this embodiment, it is preferable to provide means for displaying the information of the piping problem sensing data logger that is possibly defective (for example, a display that displays the piping problem sensing data logger that is possibly defective in a different color) according to the individual identification (ID) of the piping problem sensing data logger at the water leakage management center.

Besides the water leakage sensing of a water pipe, the piping problem sensing data logger, the piping structure, and the piping problem sensing system of the present invention can be applied to the field of the gas leakage sensing of a pipeline or the like.

While the present invention has been described above with reference to embodiments, the present invention is by no means limited thereto. Various changes and modifications that may become apparent to those skilled in the art may be made in the configuration and specifics of the present invention without departing from the scope of the present invention.

This application claims priority from Japanese Patent Application No. 2013-070886 filed on Mar. 29, 2013. The entire subject matter of the Japanese Patent Application is incorporated herein by reference.

### Explanation of Reference Numerals

1 piping problem sensing data logger
2 ground surface
3 water pipe
10 bolt portion
11 bolt thread
12 bolt head portion
13 antenna portion
21 manhole
22 manhole cover
31 water leakage site
32 bolt
33 nut
34 flange
40 relay device
50 water leakage management center
51 water leakage sensing server
121 vibration detection element
122 memory unit
123 control unit
124 wireless control unit
125 clock device
126 power-supply device
131 antenna
140 sensor housing
141 packing
142 bolt head cap
143 screw

1. A piping problem sensing data logger comprising:
a bolt portion comprising:
a bolt head portion; and
a bolt thread; and
an antenna portion disposed on an opposite side of the bolt head portion from the bolt thread or disposed in the bolt head portion, wherein
the bolt head portion comprises a vibration detection element, a memory unit, a control unit, a wireless control unit, a clock device, and a power-supply device.

2. The piping problem sensing data logger according to claim 1, wherein
the bolt head portion is composed of a bolt head cap, a sensor housing, and a packing,
the bolt head cap is connected to the antenna portion,
the sensor housing is connected to the bolt thread,
the wireless control unit is disposed on a surface of the bolt head cap adjacent to the sensor housing,
the vibration detection element, the memory unit, the control unit, the clock device, and the power-supply device are housed in the sensor housing, and
the bolt head cap and the sensor housing are joined with the packing interposed therebetween.

3. The piping problem sensing data logger according to claim 1, wherein the piping problem sensing data logger is a bolt that connects piping units.

4. The piping problem sensing data logger according to claim 1, wherein
the piping is a water pipe, and
the piping problem sensing data logger senses a water leakage of the water pipe.

5. A piping structure in which a plurality of piping units are connected, wherein
at least one of bolts that connect adjacent piping units is the piping problem sensing data logger according to claim 1.

6. A piping structure in which a plurality of piping units are connected, wherein at least two of bolts that connect adjacent piping units are the piping problem sensing data loggers according to claim 1.

7. The piping structure according to claim 6, wherein at least two pieces of vibration data are acquired by at least two piping problem sensing data loggers.

8. The piping structure according to claim 5, wherein
the piping is a water pipe, and
the piping problem sensing data logger senses a water leakage of the water pipe.

9. A piping problem sensing system comprising:
a piping problem sensing data logger; and
a server, wherein
the piping problem sensing data logger is the piping problem sensing data logger according to claim 1, and the server is connected to the piping problem sensing data logger via a communication network and analyzes vibration data acquired by the piping problem sensing data logger.

10. The piping problem sensing system according to claim 9, further comprising:
a relay device, wherein
the relay device is connected wirelessly to the piping problem sensing data logger, and
the server is connected to the relay device via a communication network.

11. The piping problem sensing system according to claim 9, wherein at least two of bolts that connect adjacent piping units are piping problem sensing data loggers as previously defined.

12. The piping problem sensing system according to claim 11, wherein at least two pieces of vibration data are acquired by at least two piping problem sensing data loggers.

13. The piping problem sensing system according to claim 12, wherein
a piping problem sensing data logger that acquired stronger vibration data among at least two piping problem sensing data loggers is identified to determine a location where a problem is caused in the piping.

14. The piping problem sensing system according to claim 9, wherein
at least three of bolts that connect adjacent piping units are piping problem sensing data loggers as previously defined,
the respective pieces of vibration data acquired by the respective piping problem sensing data loggers are compared one another in the server, and
a piping problem sensing data logger that acquired vibration data significantly different from those of other piping problem sensing data loggers is determined to be defective.

15. The piping problem sensing system according to claim 9, wherein
the piping is a water pipe, and
the piping problem sensing data logger senses a water leakage of the water pipe.

16. The piping problem sensing data logger according to claim 2, wherein the piping problem sensing data logger is a bolt that connects piping units.

17. A piping structure in which a plurality of piping units are connected, wherein
at least one of bolts that connect adjacent piping units is the piping problem sensing data logger according to claim 2.

18. A piping structure in which a plurality of piping units are connected, wherein at least two of bolts that connect adjacent piping units are the piping problem sensing data loggers according to claim 2.

19. A piping problem sensing system comprising:
a piping problem sensing data logger; and
a server, wherein
the piping problem sensing data logger is the piping problem sensing data logger according to claim 2, and
the server is connected to the piping problem sensing data logger via a communication network and analyzes vibration data acquired by the piping problem sensing data logger.

20. The piping problem sensing system according to claim 10, wherein at least two of bolts that connect adjacent piping units are piping problem sensing data loggers as previously defined.
